(19) United States
(12) Patent Application Publication
(10) Pub. No.: US 2013/0309588 A1
(43) Pub. Date: Nov. 21, 2013

(54) INTEGRATED CRYO-ADSORBER HYDROGEN STORAGE SYSTEM AND FUEL CELL COOLING SYSTEM

(71) Applicant: Senthil K. Vadivelu, Bangalore (IN)

(72) Inventor: Senthil K. Vadivelu, Bangalore (IN)

(73) Assignee: GM GLOBAL TECHNOLOGY OPERATIONS LLC, Detroit, MI (US)

(21) Appl. No.: 13/534,375

(22) Filed: Jun. 27, 2012

(30) Foreign Application Priority Data
May 15, 2012 (IN) 547/KOL/2012

(51) Int. Cl. H01M 8/04

(52) U.S. Cl. 429/435; 429/434

(57) ABSTRACT

One embodiment may include an integrated fuel supply and cooling system for a fuel cell including a fuel cell stack and a fuel cell stack cooling system; a cryo-adsorber including a bed of particles for adsorbing hydrogen fluid; wherein the cryo-adsorber may be in heat transfer communication with the fuel cell stack cooling system and in fluid communication with the fuel cell stack.

### CROSS-REFERENCE TO RELATED APPLICATIONS

This application claims priority to Indian Provisional Application Serial No. 547/KOL/2012 filed May 15, 2012.

### TECHNICAL FIELD

The field to which the disclosure generally relates includes hydrogen fuel cells, and more specifically, methods and systems to store hydrogen as well as fuel cell systems.

### BACKGROUND

The radiator of an internal combustion (IC) engine is designed to operate at about 120° C. Additionally, the IC engine rejects a significant amount of heat through its exhaust, unlike a hydrogen powered fuel cell vehicle. Hence, proton exchange membrane (PEM) fuel cell vehicle radiators are typically twice as big as that of the IC engine vehicles of the same capacity, leading to increased mass, cost, packaging issues and drag, which decreases the fuel efficiency.

On the other hand, fuel cell systems have a higher efficiency compared to IC engines. Typical fuel cell vehicle designs may provide two small radiators exclusively for cooling power electronics and a large radiator for the fuel cell cooling system.

In order to downsize the radiators or eliminate radiators from vehicle cooling systems, prior art approaches have included enhancing the heat transfer in the radiator, such as the usage of swirl gas flow, two phase flow, and metal or graphite foams instead of the conventional fins.

Another prior art approach has included using high temperature membranes that do not require moisture for proton transport. A shortcoming of this approach is that a low fuel cell operating temperature is preferred because it offers a quicker start under cold conditions.

Many hydrogen powered fuel cells, such as proton exchange membrane (PEM) fuel cells, typically use membranes, such as Nafion™, which require the presence of moisture to transport the protons from the anode to the cathode. Hence, many PSM fuel cells cannot operate above a range of 80-90° C.

### SUMMARY OF EXEMPLARY EMBODIMENTS OF THE INVENTION

One embodiment may include an integrated fuel supply and cooling system for a fuel cell is provided including a fuel cell stack and a fuel cell stack cooling system; a cryo-adsorber including a bed of particles for adsorbing hydrogen fluid; wherein the cryo-adsorber is in heat transfer communication with the fuel cell stack cooling system and in fluid communication with the fuel cell stack.

In another exemplary embodiment, a method of operating an integrated fuel supply and cooling system for a fuel cell stack is provided including providing a fuel cell stack and a fuel cell stack cooling system; providing a cryo-adsorber including a bed of particles for adsorbing hydrogen fluid, said cryo-adsorber in heat transfer communication with the fuel cell stack cooling system and in fluid communication with the fuel cell stack; transferring heat from the fuel cell stack to the cryo-adsorber to cause hydrogen fluid to discharge from the cryo-adsorber; and providing said discharged hydrogen fluid to the fuel cell stack.

Other illustrative embodiments of the invention will become apparent from the detailed description provided hereinafter. It should be understood that the detailed description and specific examples, while disclosing select embodiments of the invention, are intended for purposes of illustration only and are not intended to limit the scope of the invention.

### BRIEF DESCRIPTION OF THE DRAWINGS

Illustrative embodiments of the invention will become more fully understood from the detailed description and the accompanying drawings, wherein:

FIG. 1 shows an illustrative embodiment of an integrated cryo-adsorber hydrogen storage system with a fuel cell system.

FIG. 2A shows illustrative operating temperatures according to a predetermined heat input range to the integrated cryo-adsorber/fuel cell system.

FIG. 2B shows illustrative operating pressures according to a predetermined heat input range to the integrated cryo-adsorber/fuel cell system.

FIG. 3 shows an illustrative process flow of operating the integrated cryo-adsorber/fuel cell system.

### DETAILED DESCRIPTION OF EXEMPLARY EMBODIMENTS

The following description of the embodiment(s) is merely illustrative in nature and is in no way intended to limit the invention, its application, or uses.

In an illustrative embodiment, a conventional cryo-adsorber may be integrated into the cooling system of a fuel cell stack. In some embodiments, the fuel cell may be a proton exchange membrane (PSM) fuel cell. In other embodiments, the PEM fuel cell may include a membrane that requires the presence of moisture. In some embodiments the fuel cell (including fuel cell cooling system) may operate at a temperature of about 70° C. to about 90° C., in other embodiments, the fuel cell stack cooling system may operate at a temperature of less than about 90° C., and in other embodiments, may operate at a temperature of less than about 85° C., and in yet other embodiments may operate at a temperature of equal to or less than about 80° C.

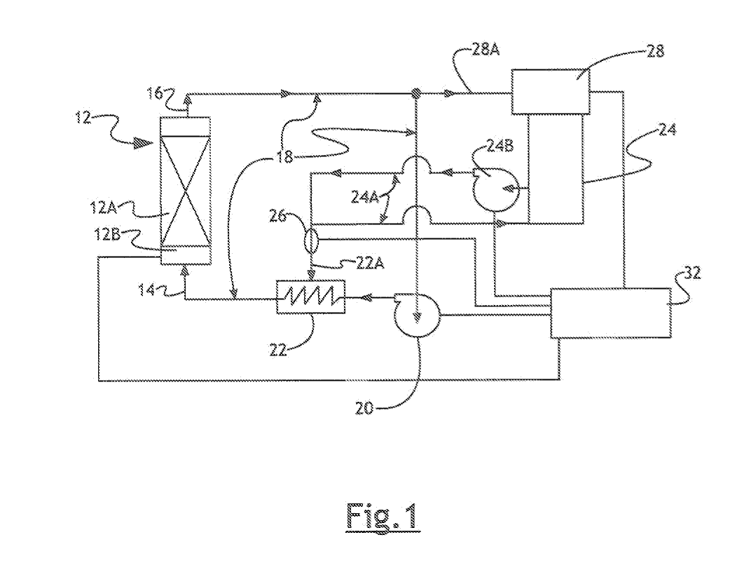

Referring to FIG. 1, is shown an illustrative embodiment of integration of a cryo-adsorber system with a fuel cell system including a fuel cell cooling system. In one embodiment, a conventional cryo-adsorber tank 12 may be provided within a recirculating fluid flow circuit 18 with a fluid (e.g., gaseous) feed input 14 and a fluid discharge output 16. The recirculating circuit 18 may include a fluid pump 20 located anywhere in the recirculating circuit 18, and in one embodiment, may be upstream of a heat exchanger 22 also in-line in the recirculating circuit 18. The heat exchanger 22 may be in heat transfer contact (thermal contact) with a heat input 22A which may receive heat from a fuel cell cooling system 24 (e.g., via a circulating heated gas stream e.g., 24A) which is coupled with a fuel cell 28 which may include a fuel cell stack. In some embodiments, the fuel cell cooling system 24 may include none or one more radiators.

In one embodiment, a disconnect means 26 for disconnecting the heat input 22A from heat exchanger 22, such as a switch or valve, may be coupled with the heat exchanger heat input 22A. In one embodiment, the heat input 22A may include a heat transfer rod in contact with a circulating heated gas stream e.g., 24A from the fuel cell cooling system 24. A disconnect switch 26 may be provided to disconnect the heat exchange rod (heat input 22A) out of thermal contact (heat transfer contact) with the heat exchanger 22 and/or the heated gas stream to prevent transfer of heat from the fuel cell to the heat exchanger 22. Alternatively or additionally, the disconnect means 26 may include a shut off valve that shuts off a gas flow stream from the fuel cell cooling system 24 (e.g., via flow pathway 24A) to the heat exchanger 22 and may include thermal insulation of the shut off valve which may substantially prevent heat from transferring from the valve to the heat exchanger 22.

In one embodiment of operation, heat from the fuel cell cooling system 24 may be input to the heat exchanger 22 and subsequently into the fluid-containing (e.g., including hydrogen gas) recirculating circuit 18. A heated gas stream in recirculating circuit 18 and heated by the heat exchanger 22 may be input into the cryo-adsorber tank 12 which may include a bed of an adsorbing material e.g., 12A, which may include adsorbed hydrogen gas. At a suitable temperature, endothermic desorption of the hydrogen may occur and the desorbed hydrogen gas may be discharged from the cryo-adsorber tank 12. A portion of the desorbed hydrogen gas may be supplied to a fuel input of fuel cell e.g., 28 (e.g., via flow path 28A) for subsequent use as fuel in the fuel cell and a portion may re-enter the recirculating circuit 18 and be recirculated through the cryo-adsorber tank 12 to enhance the rate of hydrogen desorption.

In some embodiments, the heat exchanger 22 may be any conventional heat exchanger including a gas-to-gas heat exchanger in heat transfer contact with (thermally exposed to) the fuel cell cooling system 24 exhaust stream as well as in heat transfer contact with recirculating gas stream in recirculating circuit 18. In some embodiments the heat exchanger 22 may include a finned-tube heat exchanger. In other embodiments, the heat exchanger 22 may include a heat conducting rod.

In some embodiments, the cryo-adsorber tank 12 may be a conventional cryo-adsorber tank including conventional adsorbing materials in an adsorbing bed 12A that may operate (desorb adsorbed hydrogen gas) at preferred operating temperatures according to different embodiments, e.g., in one embodiment at about 80° C. or less. In one embodiment, the cryo-adsorber tank may include activated carbon.

In some embodiments the circulating heated gas stream e.g., 24A from the fuel cell cooling system 24 includes an in-line fluid pump 24B to provide a flow rate of the heated gas stream e.g., 24A to the heat exchanger.

In one embodiment, a controller 32 may be included in signal communication (e.g., wired or wireless) with pump 20 which may control a flow rate of fluid in the recirculating fluid circuit 18 which may in turn control a heat input rate to the cryo-adsorber 12. In another embodiment, the controller 32 may be additionally in signal communication with pump 24B which may control a flow rate of fluid in the circulating heated gas stream e.g., 24A, which may in turn control a heat input rate to the heat exchanger 22 and the cryo-adsorber 12. In another embodiment, the controller 32 may be included in signal communication with the fuel cell 28 to control an operating temperature, and thereby may control a heat input rate from the fuel cell circulating exhaust stream e.g., 24A to the heat exchanger 22 and the cryo-adsorber 12. In another embodiment, the controller 32 may be included in signal communication with a pressure sensor e.g., 12B in the cryo-adsorber 12, to sense an operating pressure of the cryo-adsorber.

In another embodiment, the controller 32 may be included in signal communication with the thermal disconnect switch 26 in order to disconnect from thermal contact (thermally isolate) the heat exchanger 22 and the circulating gas stream 24A, e.g., in some embodiments, when the fuel cell is not operating or during a cold start. In one embodiment, the thermal disconnect switch 26 may be engaged in thermal contact (heat transfer contact) with the heat exchanger 22 when the fuel cell 28 has reached a predetermined operating temperature.

In some embodiments, a heat input rate to the cryo-adsorber may be selected (e.g. according to preprogrammed control by e.g., controller 32) so that the operating pressure of the system (e.g., including cryo-adsorber) does not fall below a selected lower pressure bound and does not rise above a selected upper pressure bound.

In one embodiment, a heat input rate to the cryo-adsorber may be selected (e.g. according to preprogrammed control by e.g., controller 32) so that the operating pressure of the cryo-adsorber (system) does not fall below atmospheric pressure. For example, in some embodiments, the heat input rate to the cryo-adsorber may be controlled (by e.g., controller 32) by controlling the heat transfer rate from the fuel cell cooling system (e.g., one or more of the fuel cell operating temperature, flow rate of fuel cell exhaust stream 24A, and the flow rate of the recirculating gas stream in the recirculating circuit 18.

In another embodiment, a heat input rate to the cryo-adsorber may be selected so that the operating pressure of the cryo-adsorber (system) does not rise above a vent pressure of the cryo-adsorber. In one embodiment, the vent pressure of the cryo-adsorber may be in the range from about 20 to 30 bar, including about 25 bar.

In one embodiment, in controlling a heat input rate to the cryo-adsorber, an upper bound of a heat input rate and a lower bound of heat input rate may be determined based on a selected constant operating rate of discharge of hydrogen gas from the cryo-adsorber and a corresponding predetermined upper and lower operating pressure bounds for the cryo-adsorber (system).

In one embodiment, the heat input rate may have a lower bound of about 2 to about 4 kW, preferably about 3 kW, with the cryo-adsorber operating at a constant gas discharge rate of about 2 g/s.

In another embodiment, the heat input rate may have an upper bound of about 6 to about 8 kW, preferably about 7.3 kW with the cryo-adsorber operating at a constant gas discharge rate of about 2 g/s.

It has been found that for a fuel cell (fuel cell stack) operating at about 80° C., and having a fuel cell cooling system integrated with a cryo-adsorber according to select illustrative embodiments, the net rates of heat rejection to the surrounding may be about 40 to 60 kW. A fuel cell cooling system integrated with a cryo-adsorber according to select illustrative embodiments may decrease the heat load on the fuel cell cooling system by about 5% to about 18% by a cryo-adsorber operating between about 3 kW to about 7.3 kW, compared to a fuel cell cooling system without an integrated cryo-adsorber.

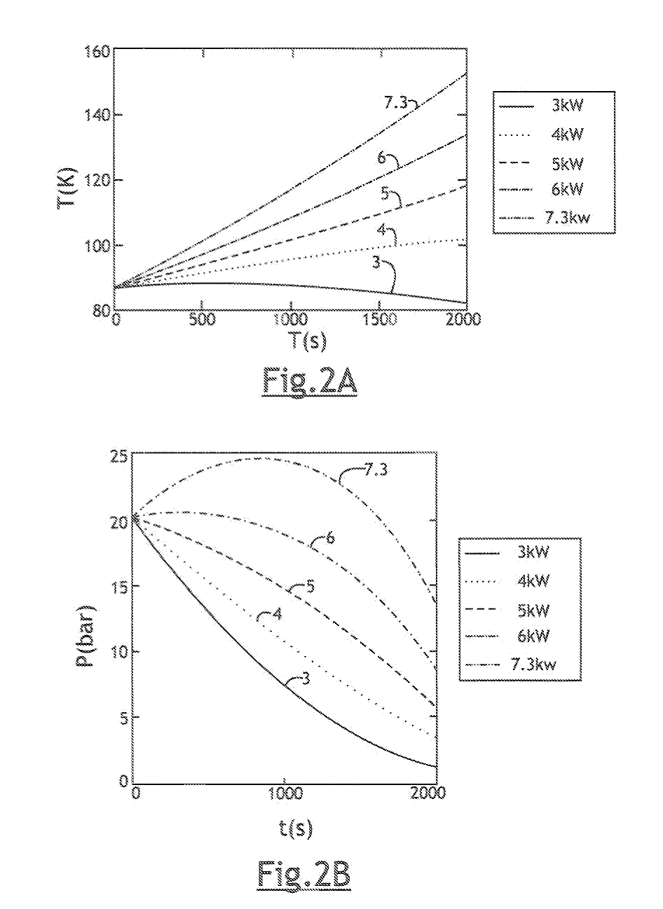

For example, FIGS. 2A and 2B illustrate a lumped-parameter model for the operation of a cryo-adsorber tank operating at a constant gas discharge (e.g., hydrogen desorption) of 2 g/s where the temperature of a cryo-adsorber tank versus time is shown in FIG. 2A and pressure versus time shown in FIG. 2B.

In the illustrative model shown, a lower bound of 3 kW heat input rate was selected for a constant discharge of 2 g/s. The lower bound of heat input rate was selected so that a final cryo-adsorber tank pressure does not fall below the atmospheric pressure in order to avoid any air leak into the tank).

As seen in FIG. 2A, at higher heat input rates (e.g., 4, 5, 6, and 7.3 kW), the cryo-adsorber tank pressure may rise over time due to a corresponding temperature rise, even though gas is being discharged continuously. In addition, an upper heat input rate bound of 7.3 kW was chosen to ensure that the system pressure never rises above the cryo-adsorber tank vent pressure 25 bar.

It has been found that a fuel cell cooling system integrated with a cryo-adsorber according to illustrative embodiments may decrease the heat load on the fuel cell cooling system by about 5% to about 18% compared to a fuel cell cooling system without an integrated cryo-adsorber.

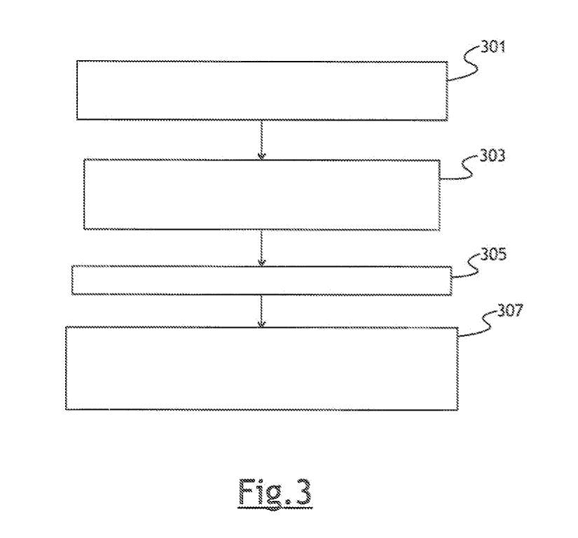

Referring to FIG. 3, is shown a process flow diagram for controlling a heat input rate to an integrated cryo-adsorber/fuel cell system according to one illustrative embodiment. In step 301, a fuel cell exhaust stream may be provided in heat exchange communication with a cryo-adsorber and an output of the cryo-adsorber may be provided via a recirculating hydrogen gas discharge stream in fluid communication with a fuel cell stack. In step 303 an upper and lower bound of a heat input rate range to the cryo-adsorber from the fuel cell exhaust stream may be determined according to a desired hydrogen gas discharge rate from the cryo-adsorber as well as an upper and lower operating pressure bound of the cryo-adsorber. In step 305, the heat input rate may be controlled within the determined range by controlling one or more of a fuel cell operating temperature, a flow rate of the fuel cell exhaust stream, and a flow rate of the recirculating hydrogen gas discharge stream. In step 307 a portion of the hydrogen gas discharged from the cryo-adsorber is provided to the fuel cell and a portion recirculated to the cryo-adsorber.

Select illustrative embodiment may provide for a decrease in the heat load on the fuel-cell cooling system by about 5% to 18%, thus allowing one or more radiators in the fuel-cell cooling system to be reduced in size and or eliminating one or more radiators. The embodiments may be particularly advantageous in automotive applications including electric and hybrid vehicles using a fuel cell power source.

The following description identifies select embodiments with reference to an embodiment number. The scope of the invention includes a variety of combinations of elements and component including, but not limited to, the combinations set forth below and combinations that a person skilled in the art would find apparent from the descriptions set forth herein.

Embodiment 1 may include an integrated fuel supply and cooling system for a fuel cell comprising: a fuel cell stack and a fuel cell stack cooling system; a cryo-adsorber comprising a bed of particles for adsorbing hydrogen fluid; wherein said cryo-adsorber is in heat transfer communication with said fuel cell stack cooling system and in fluid communication with said fuel cell stack.

Embodiment 2 may include the integrated fuel supply and cooling system as set forth in embodiment 1, further comprising a heat exchanger in heat transfer communication with heated fluid comprising said fuel cell stack cooling system, said heat exchanger further in heat transfer communication said cryo-adsorber.

Embodiment 3 may include the integrated fuel supply and cooling system as set forth in any of embodiments 1-2, wherein said heat exchanger comprises a means for engaging and disengaging said heat exchanger from heat transfer communication with heated fluid comprising said fuel cell stack cooling system.

Embodiment 4 may include the integrated fuel supply and cooling system as set forth in any of embodiments 1-3, wherein said heat exchanger is in heat transfer communication with said heated fluid comprising said fuel cell stack cooling system through a heat exchange rod.

Embodiment 5 may include the integrated fuel supply and cooling system as set forth in any of embodiments 1-4, wherein said heat exchange rod is moveable to engage and disengage heat transfer communication with said heat exchanger.

Embodiment 6 may include the integrated fuel supply and cooling system as set forth in any of embodiments 1-5, further comprising a fluid input flow pathway from said heat exchanger to said cryo-adsorber.

Embodiment 7 may include the integrated fuel supply and cooling system as set forth in any of embodiments 1-6, further comprising a fluid output flow pathway from said cryo-adsorber in fluid communication with said fuel cell stack.

Embodiment 8 may include the integrated fuel supply and cooling system as set forth in any of embodiments 1-7, further comprising a recirculating fluid circuit in recirculating fluid communication with said cryo-adsorber, said recirculating fluid circuit further in fluid communication with a fuel supply input comprising said fuel cell stack.

Embodiment 9 may include the integrated fuel supply and cooling system as set forth in any of embodiments 1-8, wherein said recirculating fluid circuit is arranged to recirculate a first portion of fluid discharged from said cryo-adsorber back into said cryo-adsorber and output a second portion of fluid discharged from said cryo-adsorber to said fuel supply input.

Embodiment 10 may include the integrated fuel supply and cooling system as set forth in any of embodiments 1-9, wherein said recirculating fluid circuit comprise's a fluid pump adapted to control a recirculating fluid flow rate to said cryo-adsorber.

Embodiment 11 may include the integrated fuel supply and cooling system as set forth in any of embodiments 1-10, wherein said cryo-adsorber is adapted to operate at a pressure between about atmospheric and a vent pressure of said cryo-adsorber.

Embodiment 12 may include the integrated fuel supply and cooling system as set forth in any of embodiments 1-11, wherein said system is adapted to operate at a temperature of less than about 85° C.

Embodiment 13 may include the integrated fuel supply and cooling system as set forth in any of embodiments 1-12, wherein said system is adapted to operate at a temperature of equal to or less than about 80° C.

Embodiment 14 may include the integrated fuel supply and cooling system as set forth in any of embodiments 1-13, wherein said fuel cell stack comprises a proton exchange membrane (PEM) fuel cell.

Embodiment 15 may include the integrated fuel supply and cooling system as set forth in any of embodiments 1-14, wherein said PEM requires the presence of water to operate.

Embodiment 16 may include the integrated fuel supply and cooling system as set forth in any of embodiments 1-15, wherein said cryo-adsorber is adapted to operate at a heat input rate of about 1 kW to about 10 kW.

Embodiment 17 may include the integrated fuel supply and cooling system as set forth in any of embodiments 1-16, wherein said cryo-adsorber is adapted to operate at a heat input rate of about 3 kW to about 8 kW.

Embodiment 18 may include a method of operating an integrated fuel supply and cooling system for a fuel cell stack comprising: providing a fuel cell stack and a fuel cell stack cooling system; providing a cryo-adsorber comprising a bed of particles for adsorbing hydrogen fluid, said cryo-adsorber in heat transfer communication with said fuel cell stack cooling system and in fluid communication with said fuel cell stack; transferring heat from said fuel cell stack to said cryo-adsorber to cause hydrogen fluid to discharge from said cryo-adsorber; and providing said discharged hydrogen fluid to said fuel cell stack.

Embodiment 19 may include the method as set forth in embodiment 18, where the step of transferring heat comprises transferring heat from heated fluid comprising said fuel cell stack cooling system to a heat exchanger in heat transfer communication with said cryo-adsorber.

Embodiment 20 may include the method as set forth in any of embodiments 18-19, further comprising providing a recirculating fluid circuit in recirculating fluid communication with said cryo-adsorber, said recirculating fluid circuit in said fluid communication with said fuel cell stack via a fuel supply input.

The above description of embodiments of the invention is merely illustrative in nature and, thus, variations thereof are not to be regarded as a departure from the spirit and scope of the invention.

What is claimed is:

1. An integrated fuel supply and cooling system for a fuel cell comprising:
a fuel cell stack and a fuel cell stack cooling system;
a cryo-adsorber comprising a bed of particles for adsorbing hydrogen fluid;
wherein said cryo-adsorber is in heat transfer communication with said fuel cell stack cooling system and in fluid communication with said fuel cell stack.

2. The integrated fuel supply and cooling system of claim 1, further comprising a heat exchanger in heat transfer communication with heated fluid comprising said fuel cell stack cooling system, said heat exchanger further in heat transfer communication said cryo-adsorber.

3. The integrated fuel supply and cooling system of claim 2, wherein said heat exchanger comprises a means for engaging and disengaging said heat exchanger from heat transfer communication with heated fluid comprising said fuel cell stack cooling system.

4. The integrated fuel supply and cooling system of claim 2, wherein said heat exchanger is in heat transfer communication with said heated fluid comprising said fuel cell stack cooling system through a heat exchange rod.

5. The integrated fuel supply and cooling system of claim 4, wherein said heat exchange rod is moveable to engage and disengage heat transfer communication with said heat exchanger.

6. The integrated fuel supply and cooling system of claim 2, further comprising a fluid input flow pathway from said heat exchanger to said cryo-adsorber.

7. The integrated fuel supply and cooling system of claim 1, further comprising a fluid output flow pathway from said cryo-adsorber in fluid communication with said fuel cell stack.

8. The integrated fuel supply and cooling system of claim 1, further comprising a recirculating fluid circuit in recirculating fluid communication with said cryo-adsorber, said recirculating fluid circuit further in fluid communication with a fuel supply input comprising said fuel cell stack.

9. The integrated fuel supply and cooling system of claim 8, wherein said recirculating fluid circuit is arranged to recirculate a first portion of fluid discharged from said cryo-adsorber back into said cryo-adsorber and output a second portion of fluid discharged from said cryo-adsorber to said fuel supply input.

10. The integrated fuel supply and cooling system of claim 8, wherein said recirculating fluid circuit comprises a fluid pump adapted to control a recirculating fluid flow rate to said cryo-adsorber.

11. The integrated fuel supply and cooling system of claim 1, wherein said cryo-adsorber is adapted to operate at a pressure between about atmospheric and a vent pressure of said cryo-adsorber.

12. The integrated fuel supply and cooling system of claim 1, wherein said system is adapted to operate at a temperature of less than about 85° C.

13. The integrated fuel supply and cooling system of claim 1, wherein said system is adapted to operate at a temperature of equal to or less than about 80° C.

14. The integrated fuel supply and cooling system of claim 1, wherein said fuel cell stack comprises a proton exchange membrane (PEM) fuel cell.

15. The integrated fuel supply and cooling system of claim 1, wherein said PEM requires the presence of water to operate.

16. The integrated fuel supply and cooling system of claim 1, wherein said cryo-adsorber is adapted to operate at a heat input rate of about 1 kW to about 10 kW.

17. The integrated fuel supply and cooling system of claim 1, wherein said cryo-adsorber is adapted to operate at a heat input rate of about 3 kW to about 8 kW.

18. A method of operating an integrated fuel supply and cooling system for a fuel cell stack comprising:
providing a fuel cell stack and a fuel cell stack cooling system;
providing a cryo-adsorber comprising a bed of particles for adsorbing hydrogen fluid, said cryo-adsorber in heat transfer communication with said fuel cell stack cooling system and in fluid communication with said fuel cell stack;
transferring heat from said fuel cell stack to said cryo-adsorber to cause hydrogen fluid to discharge from said cryo-adsorber; and
providing said discharged hydrogen fluid to said fuel cell stack.

19. The method of claim 18, where the step of transferring heat comprises transferring heat from heated fluid comprising said fuel cell stack cooling system to a heat exchanger in heat transfer communication with said cryo-adsorber.

20. The method of claim 18, further comprising providing a recirculating fluid circuit in recirculating fluid communication with said cryo-adsorber, said recirculating fluid circuit in said fluid communication with said fuel cell stack via a fuel supply input.
